(19) United States
(12) Patent Application Publication
(10) Pub. No.: US 2017/0204823 A1
(43) Pub. Date: Jul. 20, 2017

(54) Roller for a roller plunger of a high pressure fuel pump, roller plunger, high pressure fuel pump, and internal combustion engine

(71) Applicant: CONTINENTAL AUTOMOTIVE GMBH, Hannover (DE)

(72) Inventor: Andreas Ederer, Walderbach (DE)

(73) Assignee: Continental Automotive GmbH, Hannover (DE)

(21) Appl. No.: 15/114,032

(22) PCT Filed: Sep. 16, 2015
(86) PCT No.: PCT/EP2015/071186

§ 371 Date: Jul. 25, 2016

(30) Foreign Application Priority Data
Oct. 8, 2014 (DE) 10 2014 220 374.0
Nov. 19, 2014 (DE) 10 2014 223 597.9

(51) Int. Cl. F02M 59/10; F04B 9/04; F16C 13/00; F04B 17/05

(52) U.S. Cl. CPC F02M 59/102; F04B 17/05; F04B 9/04; F16C 13/00; F02M 2200/9053; F02M 2200/9015

(57) ABSTRACT

The present disclosure relates to internal combustion engines and the teachings may be applied to a roller for a roller plunger of a high pressure fuel pump, to a roller plunger which is equipped with a roller of this type, to a high pressure fuel pump which has said roller plunger, and/or to an internal combustion engine having a crankshaft which comprises the high pressure fuel pump. A roller for a roller plunger of a high pressure fuel pump may include a first roller region comprising a first material, a second roller region comprising a second material, the first material and the second material connected to one another in order to form a composite roller volume element, and the first material having a lighter density than the second material.

### CROSS-REFERENCE TO RELATED APPLICATIONS

This application is a U.S. National Stage Application of International Application No. PCT/EP2015/071186 filed Sep. 16, 2015, which designates the United States of America, and claims priority to DE Application No. 10 2014 220 374.0 filed Oct. 8, 2014 and DE 10 2014 223 597.9 filed Nov. 19, 2014, the contents of which are hereby incorporated by reference in their entirety.

### TECHNICAL FIELD

The present disclosure relates to internal combustion engines and the teachings may be applied to a roller for a roller plunger of a high pressure fuel pump, to a roller plunger which is equipped with a roller of this type, to a high pressure fuel pump which has said roller plunger, and/or to an internal combustion engine having a crankshaft which comprises the high pressure fuel pump.

### BACKGROUND

High pressure fuel pumps which load a fuel to be fed to a combustion chamber of an internal combustion engine with high pressure are usually constructed as piston pumps. In these pumps, a piston compresses the fuel which is situated in a pressure space by way of a translational to and fro movement and therefore generate a high pressure in the fuel. For example, in the case of high pressure fuel pumps for gasoline internal combustion engines, the fuel is loaded with pressure of from 200 bar-250 bar, whereas the fuel is loaded with a pressure of from 2000 bar-2500 bar by high pressure pumps for diesel internal combustion engines.

Often, a shaft is used to drive the translational movement of the pump piston, the pump piston frequently being in contact with the surface of the shaft via a plunger, for example a roller plunger.

In order for it to be possible to provide in particular the high pressures of from 2000 bar-3000 bar, a drive shaft of the internal combustion engine, such as the crankshaft, is taken into consideration increasingly as a drive shaft. In order for it to be possible to maintain a sufficiently great distance of a cam for driving the pump piston from the connecting rods on the crankshaft, the crankshaft has a relatively large pitch circle diameter in the region of the cam. During driving of the pump piston, the roller of the roller plunger which is connected between the pump piston and the crankshaft then rolls on said relatively large pitch circle diameter. If the roller is of comparatively small configuration here and corresponds, for example, to a roller as usually used in the case of pumps having a dedicated camshaft as drive shaft, the rotational speed per unit time of the roller increases multiple times. For example, the rotational speed of the roller of a camshaft is usually from 5000-15 000 revolutions per minute, and the rotational speeds can increase to more than 40 000 revolutions per minute in the case of being used on the crankshaft. This leads to increased wear and to increase friction within the roller plunger and, in particular, on the roller.

In order to reduce the rotational speeds of the roller, there is the possibility to increase the roller diameter. An increase in the roller diameter results, by way of the weight of the roller which rises in a linear manner, in a large amount of rotational energy, which leads to lifting up of the roller and additional slip between the roller and the cam of the crankshaft. These effects lead to higher wear susceptibility within the high pressure fuel pump.

### SUMMARY

The teachings of the present disclosure may be applied to a roller element, a plunger which comprises said roller, a high pressure fuel pump having the roller plunger, and/or an internal combustion engine which comprises the high pressure fuel pump.

In some embodiments, a roller (26) for a roller plunger (20) of a high pressure fuel pump (14), which roller (26) is constructed as a composite roller (28) may include: a first material (40) for forming a first composite roller region (38); a second material (44) for forming a second composite roller region (42). The first material (40) and the second material (44) is connected to one another in order to form a composite roller volume element (46), The first material (40) is lighter than the second material (44).

In some embodiments, the roller (26) is configured such that it can be rotated about a rotational axis (52). The first composite roller region (38) is configured as a first layer (48) which extends in the radial direction away from the rotational axis (52). The second composite roller region (42) is configured as a second layer (50) which extends in the radial direction away from the rotational axis (52). The first layer (48) is arranged, in particular, closer to the rotational axis (52) than the second layer (50).

In some embodiments, the first layer (48) and the second layer (50) are of circumferential configuration about the rotational axis (52).

In some embodiments, the second material (44) is more resistant than the first material (40) to a rolling friction force.

In some embodiments, the first material (40) is a plastic and/or aluminum and/or a ceramic, the second material (44) being a steel.

In some embodiments, the first layer (48) is of thicker configuration in the radial direction than the second layer (50), the second layer (50) having a thickness (D) in the radial direction of from 0.5 mm to 3 mm, in particular from 1 mm to 2 mm.

In some embodiments, a roller core (63) is arranged immediately on the rotational axis (52) with an axle element (60) for forming the rotational axis (52) and with a bearing element (62), in particular a plain bearing element (64), for rotatably mounting the composite roller volume element (46) on the axle element (60), the bearing element (62) being formed, in particular, from a steel bush (66) and being connected, more particularly, to the composite roller volume element (46) in such a way that it can be rotated about the axle element (60) jointly with the composite roller volume element (46).

In some embodiments, the composite roller volume element (46) has a third composite roller region (70) which is configured as a third layer (68) which is connected to the first layer (48), extends in the radial direction away from the rotational axis (52), is arranged closer to the rotational axis (52) than the first layer (48), and which, in particular, comprises a steel.

In some embodiments, an overall diameter (d) of the roller (26) is from 35 mm to 55 mm, in particular from 40 mm to 50 mm.

Some embodiments may include a roller plunger (20) for a high pressure fuel pump (14), having a roller plunger housing (34), in which a roller (26) as described above is mounted rotatably.

Some embodiments may include a high pressure fuel pump (14), in particular a plug-in pump (30), having a pump piston (22) which is to be driven by a crankshaft (12) of an internal combustion engine (10), a roller plunger (20) with a roller (26) as claimed described above being provided in operative connection with the pump piston (22) in order to make direct contact with a crankshaft surface (24).

Some embodiments may include an internal combustion engine (10) having a crankshaft (12) and having a high pressure fuel pump (14) as described above which has a pump piston (22) and a roller plunger (20) with a roller (26), the roller (26) being arranged in direct contact with a crankshaft surface (24) and in operative contact with the pump piston (22), in order to transmit a movement of the crankshaft (12) to the pump piston (22).

### BRIEF DESCRIPTION OF THE DRAWINGS

Teachings of the present disclosure will be explained in greater detail in the following text using the appended drawings, in which:

FIG. 1 shows an internal combustion engine having a crankshaft,

FIG. 2 shows the crankshaft from FIG. 1 in a perspective view with a high pressure fuel pump which is fastened thereto,

FIG. 3 shows a sectional view of the crankshaft with a high pressure fuel pump from FIG. 2, the high pressure fuel pump having a roller plunger with a roller in operative connection with a pump piston, and

FIG. 4 shows a sectional view through the roller from FIG. 3.

### DETAILED DESCRIPTION

In some embodiments, a roller for a roller plunger of a high pressure fuel pump is constructed as a composite roller, has a first material for forming a first composite roller region and a second material for forming a second composite roller region. The first material and the second material are connected to one another in order to form a composite roller volume element, the first material being lighter than the second material.

As a result of the construction of a composite roller from at least two different materials, it is possible to produce different properties of the roller in different regions of the roller which is subjected to different requirements, which different properties then satisfy the corresponding requirements. It is possible at the same time, if one of the materials is lighter than the other one of the materials, to save weight on the roller, as a result of which disadvantages are compensated for which are associated with a heavier roller, such as lifting up of the roller and the additional slip between the roller and the cam as a result of the great rotational energy of a heavy roller. If a large roller with a weight which is similar to a small roller can then be produced by way of the composite construction, a large roller of this type can be used as contact element with the crankshaft, and lower rotational speeds result by way of the larger roller diameter than if a small roller is used. As a result, the wear of the roller and therefore, overall, of the roller plunger is reduced.

The overall weight and the rotational energy of the roller plunger can be reduced considerably by way of said composite construction. As a result, it is possible to operate a roller plunger with a large roller at the rotational speeds which prevail, for example, in a passenger motor vehicle internal combustion engine. As a result of this measure, the wear and the friction within the roller plunger can be reduced considerably.

A further advantage consists in that a spring with a reduced force can be used, which spring presses the roller plunger onto the cam and therefore prevents it being lifted up.

The roller may be rotated about a rotational axis, the first composite roller region configured as a first layer which extends in the radial direction away from the rotational axis, the second composite roller region configured as a second layer which extends in the radial direction away from the rotational axis, the first layer may be arranged closer to the rotational axis than the second layer.

The roller as composite roller may be produced by way of layered construction of the different materials, which may be manufactured particularly simply. The first layer with the first material may be arranged closer to the rotational axis than the second layer. The first layer and the second layer may be of circumferential configuration about the rotational axis.

This means that the second layer may surround the first layer. This results in cross section through the roller in a first circular ring, formed from the first, lighter material, and a second circular ring which surrounds the first circular ring, formed from the second, heavy material. Weight may be saved in the interior of the roller.

The second material may be more resistant than the first material to a rolling friction force. The second, heavy material may be arranged as a second, outer circular ring around the first material. The composite roller may be constructed in such a way that a light material is arranged in the interior, which light material is subjected only to low loading, in particular low frictional loading, with the result that a large selection of materials are appropriate. The heavier material which is more resistant, in particular, to rolling friction forces may be arranged in the outer region and therefore in the region which is actually subjected to a rolling friction force during operation.

Therefore, a roller which is light and nevertheless resistant may be produced.

The first material may include a plastic and/or an aluminum and/or a ceramic. Here, a multiplicity of plastics are available which can be selected according to their coefficient of expansion and can be adapted to the coefficients of expansion of the second, heavier material.

The second material may include a steel. Steel is inexpensively available and, moreover, can resist the high rolling friction forces in the outer region of the roller during operation.

The first layer may be of thicker configuration in the radial direction than the second layer. For example, the second layer has a thickness in the radial direction of from 0.5 mm-3 mm, in particular from 1 mm-2 mm.

The thicker the first layer with the lighter material, the greater the weight saving which can be achieved. The second layer arranged in the outer region of the roller may have a thickness which makes a satisfactory resistance against rolling friction forces possible. Thicknesses in the range from 0.5 mm-3 mm, or in the range from 1 mm-2 mm may serve.

A roller core may be disposed on the rotational axis with an axle element for forming the rotational axis and with a bearing element, in particular a plain bearing element, for rotatably mounting the composite roller volume element on the axle element.

By way of the axle element and the bearing element, the roller can be mounted rotatably, for example, in a roller plunger. Here, the axle element affords sufficient stability in the region of the rotational axis of the roller, and the bearing element serves to mount the composite roller volume element in such a way that it can be rotated about the rotational axis.

On account of the great prevailing forces during operation of the roller, that is to say when in contact with the crankshaft, a resistant plain bearing element may be employed. For example, the bearing element may be formed from a steel bushing and therefore have a relatively large resistance to rolling friction forces in contact with the axle element.

The bearing element may be connected to the composite roller volume element, with the result that it rotates about the axle element together with the composite roller volume element. As a result, further friction forces between the composite roller volume element and the bearing element can be avoided.

In some embodiments, the composite roller volume element has a third composite roller region configured as a third layer connected to the first layer and extending in the radial direction away from the rotational axis. Said third layer may be arranged closer to the rotational axis than the first layer. The third layer can therefore form a supporting layer for supporting the first, lighter and less resistant layer. In order for it to be possible to act as a support, the third layer may comprise a steel or be formed completely from steel.

In some embodiments, the roller may have an overall diameter of from 35 mm-55 mm, in particular from 40 mm-50 mm.

If a crankshaft is used as drive element, the region around the cam usually has a diameter of approximately 160 mm. In order that the roller can run at rotational speeds which are as low as possible on said region of the crankshaft, it may have a relatively large diameter in the range from 35 mm-55 mm. Customary rollers in roller plungers which run on usually used camshafts with a diameter of approximately 70 mm usually have a diameter of only approximately 20 mm.

In some embodiments, a roller plunger for a high pressure fuel pump has a roller plunger housing, in which an above-described roller is mounted rotatably, and therefore has the same advantages which have already been described in relation to the roller.

In some embodiments, a high pressure fuel pump is configured as a plug-in pump, that is to say it does not have a dedicated housing, but rather the engine block of an internal combustion engine is used as a housing. Said high pressure fuel pump may be driven by a crankshaft of an internal combustion engine, by a pump piston being moved by a roller plunger which is in direct contact with a crankshaft surface. Here, the roller plunger has the above-described roller.

In some embodiments, an internal combustion engine has a crankshaft and a high pressure fuel pump which has a pump piston and a roller plunger with the above-described roller, the roller arranged in direct contact with a crankshaft surface and in contact with the pump piston, in order to transmit a movement to the pump piston.

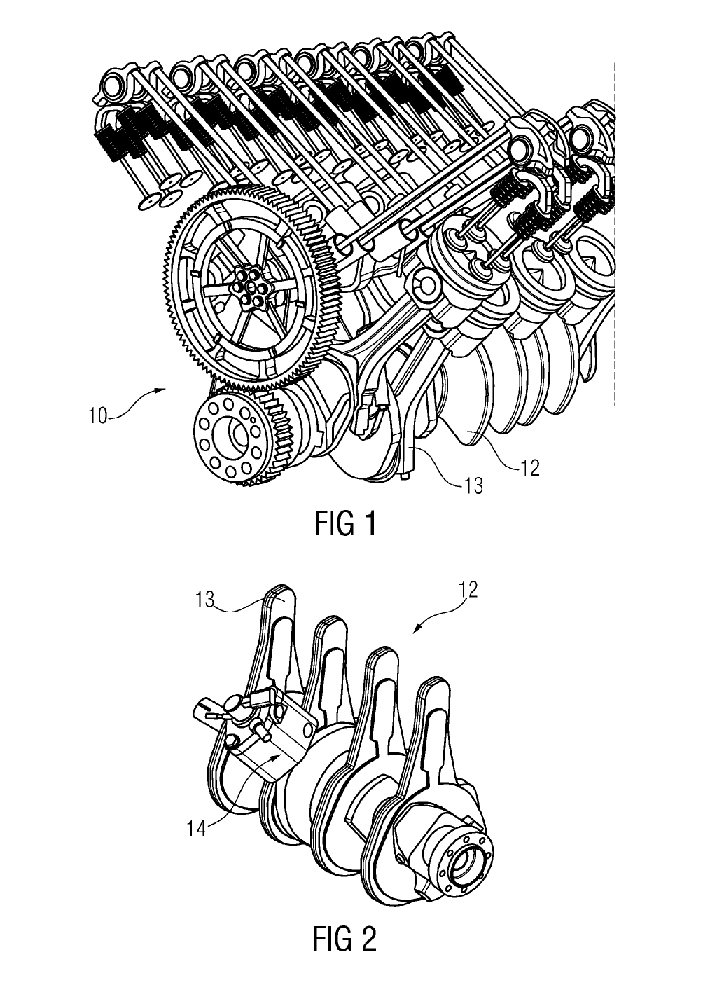

FIG. 1 shows a perspective illustration of a detail from an internal combustion engine 10 which has a crankshaft 12.

FIG. 2 shows a perspective illustration of the crankshaft 12 which is shown in FIG. 1, has a plurality of connecting rods 13, and on which a high pressure fuel pump 14 acts.

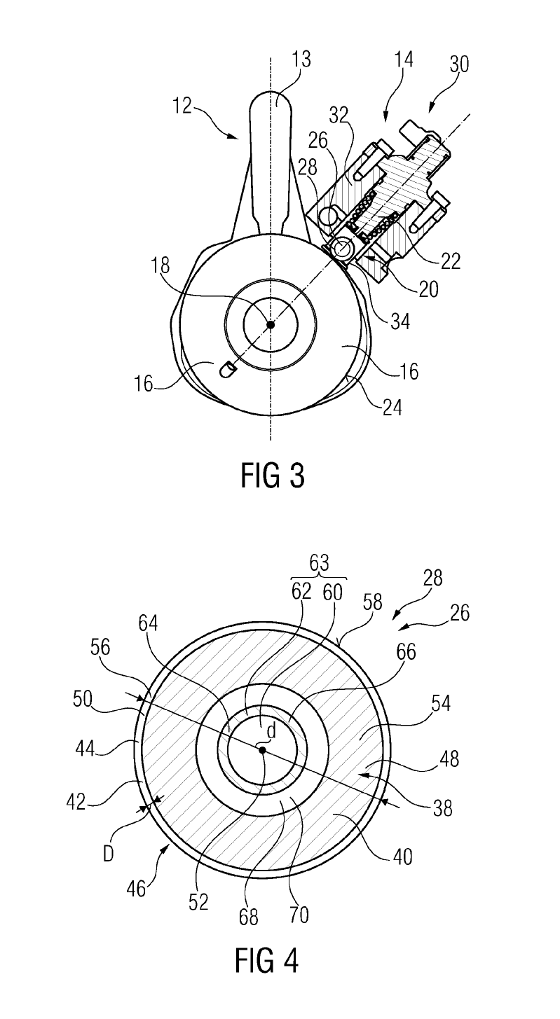

FIG. 3 shows a sectional view of the crankshaft 12 with the high pressure fuel pump 14 from FIG. 2.

The crankshaft 12 has two cams 16 which come into contact periodically with a roller plunger 20 of the high pressure fuel pump 14 as a result of the rotation of the crankshaft 12 about its crankshaft rotational axis 18, and in the process move a pump piston 22 up and down which is in operative contact with the roller plunger 20.

A roller 26 of the roller plunger 20 is in direct contact with a crankshaft surface 24, which roller 26 is configured as a composite roller 28, as will be described later in conjunction with FIG. 4.

The high pressure fuel pump 14 is formed as a plug-in pump 30 and does not have a dedicated housing, but rather uses an engine block 32 of the internal combustion engine 10 as a housing.

The roller 26 is mounted rotatably in a roller plunger housing 34 of the roller plunger 20.

During a rotation of the crankshaft 12 about its crankshaft rotational axis 18, the roller 26 rolls on the crankshaft surface 24. As soon as the roller 26 comes into contact with one of the cams 16, the roller 26 and therefore the entire roller plunger 20 with the pump piston 22 are pressed in the direction of a top dead center. As a result, a volume of a pressure space (not shown) is reduced, fuel which is present in said pressure space being compressed and therefore being loaded with high pressure.

During a further movement of the crankshaft 12 about its crankshaft rotational axis 18, the roller 26 with the roller plunger 20 and the pump piston 22 moves downward to a bottom dead center, with the result that a volume of the pressure space is increased and fuel which is not loaded with pressure can be sucked in there.

It is known for roller plungers 20 for operating the high pressure fuel pump 14 to run on cam contours, for example on a camshaft of an engine, with a relatively small pitch circle diameter. On account of the requirements of injecting at ever higher pressures, the toothed drive belts of the camshafts and the camshaft adjusters are reaching their load limits, however. Therefore, as shown in FIG. 3, the high pressure fuel pump 14 is now operated directly on the crankshaft 12. As a result, however, a relatively large pitch circle diameter of the cams 16 becomes necessary, in order for it to be possible to maintain the necessary spacing from the connecting rods 13 on the crankshaft 12.

If standard roller plungers were used, as are used in conjunction with camshafts, the roller 26 would rotate multiple times more quickly on the crankshaft 12 than in the case of a use on the camshaft. For example, in the case of a use on a camshaft of the engine, the rotational speed of the roller 26 is typically from 5000 revolutions per minute to 15 000 revolutions per minute. In the case of the use of the crankshaft 12, however, the rotational speeds can be expected in the range of 40 000 revolutions per minute or higher. This leads to increased wear and to increased friction within the roller plunger 20.

In order to reduce the rotational speeds of the roller 26, it is then proposed to increase the roller diameter. This is known, for example, in the case of slowly running engines, such as marine diesel engines. The high weight of a large roller 26 of this type, however, results at high rotational speeds in lifting up of the roller 26 and slip between the roller 26 and the cam 16, since the roller 26 has a very high rotational energy, and thus can no longer follow the dynamics at high rotational speeds.

It is therefore then proposed to construct the roller 26 as a composite roller 28, which is shown in FIG. 4 in a cross section through the roller 26.

The roller has a first composite roller region 38 formed from a first material 40 and a second composite roller region 42 formed from a second material 44. The first material 40 and the second material 44 are connected to one another in such a way that they form a composite roller volume element 46, that is to say an element which acts during movement of the roller 26 as if it were formed from a single material.

Here, the first material 40 is lighter than the second material 44. Although the roller 26 is therefore formed like a composite roller volume element 46 which acts as a single element, considerable weight saving can be achieved, however, in comparison with standard rollers which are actually formed from only one material. As a result, forces which act on the roller 26 and the roller plunger 20 are reduced, since the rotational energy which is directly proportional to the weight of the roller 26 is reduced.

In the present embodiment, the two composite roller regions 38, 42 are configured as layers 48, 50 which extend in the radial direction away from a rotational axis 52 of the roller 26. Here, the first layer 48 is arranged closer to the rotational axis 52 than the second layer 50. In particular, both layers 48, 50 are formed circumferentially about the rotational axis 52.

In the cross-sectional view of the roller 26, this therefore results in a first circular ring 54, formed from the first material 40, which is surrounded by a second circular ring 56, formed by the second material 44.

In a three-dimensional embodiment, the roller 26 can be configured, for example, as a circular cylinder which has said plurality of layers 48, 50. In the present embodiment, the second material 44 is more resistant to a rolling friction force than the first material 40.

It is also dependent on the material selection as to how each material 40, 44 is arranged as viewed from the rotational axis 52, in order to form the composite roller volume element 46. It is also conceivable to arrange the first material 40 and therefore the first layer 48 outside the second material 44, in particular when the first material 40 is more resistant to a rolling friction force instead of the second material 44.

It is unimportant where the weight saving of the roller 26 is realized. I.e., either material may be lightweight. If both materials 40, 44 have a similar resistance to rolling friction forces, it is also conceivable to arrange them on a roller surface 58 in an alternating manner.

For example, the first material 40 can be a plastic or aluminum or ceramic. The second material 44 may comprise a steel. Particularly satisfactory weight saving can be achieved by way of the composite construction of the roller 26 of the roller plunger 20 using plastic; moreover, a plastic can be selected which has a similar coefficient of expansion to steel, which is advantageous, in particular, under operating conditions.

If the plastic as first material 40, as shown in FIG. 4, is used as an inner first layer 48, damping of the jolts between the cam 16 and the high pressure fuel pump 14 can additionally be achieved during operation. This can also lead to increased robustness and an extended service life of the roller plunger 20 and the high pressure fuel pump 14 overall.

In some embodiments, the layer 48, 50 which has the lighter, first material 40 is of thicker configuration than the layer 48, 50 which has the second material 44 and therefore the heavier material.

In the embodiment which is shown in FIG. 4, the second layer 50 which forms the outer, second circle 56 and has the heavier, second material 44 may be configured with a thickness D of from 0.5 mm-3 mm. In some embodiments, it may have a thickness D of from 1 mm-2 mm. As a result, stability of the roller 26 overall can be achieved under operating conditions.

In some embodiments, an axle element 60 and a bearing element 62 which together form a roller core 63 are arranged directly on the rotational axis 52 in order to mount the roller 26. Here, the axle element 60 forms a stable rotational axis 52 for the roller 26. The bearing element 62 makes it possible that the composite roller volume element 46 is capable of rotating about the axle element 60. Since particularly great forces act on the roller 26, it is preferred if the bearing element 62 is configured as a plain bearing element 64 and is formed, for example, from a steel bush 66.

In order that the roller 26 overall becomes even more stable, the composite roller volume element 46 has a third layer 68 which extends in the radial direction away from the rotational axis 52 and is arranged closer to the rotational axis 52 than the first layer 48 and the second layer 50. For example, said third layer 68 can likewise be formed from steel.

The third layer 68 therefore forms a third composite roller region 70 of the composite roller volume element 46. A considerable weight reduction of the roller 26 can be achieved by way of the multiple-part construction of the roller 26, and it is possible to form a roller 26 which has an overall diameter d of from 35 mm-55 mm, without forces arising during operation of the roller 26 which might lead to wear of the high pressure fuel pump 14.

The third layer 68 can have, for example, a thickness D of from 1.5 mm-3.5 mm, in particular from 2 mm-3 mm.

### LIST OF DESIGNATIONS

10 Internal combustion engine
12 Crankshaft
13 Connecting rod
14 High pressure fuel pump
16 Cam
18 Crankshaft rotational axis
20 Roller plunger
22 Pump piston
24 Crankshaft surface
26 Roller
28 Composite roller
30 Plug-in pump
32 Engine block
34 Roller plunger housing
38 First composite roller region
40 First material
42 Second composite roller region
44 Second material
46 Composite roller volume element
48 First layer
50 Second layer
52 Rotational axis
54 First circular ring
56 Second circular ring
58 Roller surface
60 Axle element
62 Bearing element
63 Roller core
64 Plain bearing element
66 Steel bush
68 Third layer
70 Third composite roller region
D Thickness
d Overall diameter

What is claimed is:

1. A roller for a roller plunger of a high pressure fuel pump, the roller comprising:
a first roller region comprising a first material,
a second roller region comprising a second material,
the first material and the second material connected to one another in order to form a composite roller volume element, and
the first material having a lighter density than the second material.

2. The roller as claimed in claim 1, wherein:
the roller having a rotational axis,
the first composite roller region comprising a first layer extending in the radial direction away from the rotational axis,
the second composite roller region comprising a second layer extending in the radial direction away from the rotational axis,
the first layer disposed closer to the rotational axis than the second layer.

3. The roller as claimed in claim 2, wherein the first layer and the second layer are disposed circumferentially about the rotational axis.

4. The roller as claimed in claim 1, wherein
the second material is more resistant than the first material to a rolling friction force.

5. The roller as claimed in claim 1, wherein the first material includes a plastic, or aluminum, or a ceramic, and the second material includes steel.

6. The roller as claimed in claim 2, wherein the first layer has a greater thickness in the radial direction than the second layer, and the second layer has a thickness in the radial direction between 0.5 mm and 3 mm.

7. The roller as claimed in claim 2, further comprising:
a roller core arranged immediately on the rotational axis with an axle element for forming the rotational axis and with a bearing element for rotatably mounting the roller on the axle element,
the bearing element formed from a steel bush and connected to the composite roller volume element so that it can be rotated about the axle element jointly with the roller.

8. The roller as claimed in claim 2, further comprising a third composite roller region configured as a third layer connected to the first layer, the third layer extending in the radial direction away from the rotational axis, and arranged closer to the rotational axis
than the first layer, and the third layer comprises a steel.

9. The roller as claimed claim 1, wherein an overall diameter of the roller is from 35 mm to 55 mm.

10. A roller plunger for a high pressure fuel pump, the roller plunger comprising:
a roller plunger housing; and
a roller mounted rotatably in the roller plunger housing;
the roller comprising:
a first roller region comprising a first material,
a second roller region comprising a second material,
the first material and the second material connected to one another in order to form a composite roller volume element, and
the first material having a lighter density than the second material.

11. A high pressure fuel pump comprising:
a pump piston driven by a crankshaft of an internal combustion engine;
roller plunger in operative connection with the pump piston in order to make direct contact with a crankshaft surface, the roller plunger comprising:
a roller plunger housing; and
a roller mounted rotatably in the roller plunger housing;
the roller comprising:
a first roller region comprising a first material,
a second roller region comprising a second material,
the first material and the second material connected to one another in order to form a composite roller volume element, and
the first material having a lighter density than the second material.

12. An internal combustion engine comprising:
a crankshaft;
a pump piston; and
a roller plunger with a roller arranged in direct contact with a crankshaft surface and in operative contact with the pump piston, in order to transmit a movement of the crankshaft (12) to the pump piston;
the roller plunger comprising:
a roller plunger housing; and
a roller mounted rotatably in the roller plunger housing;
the roller comprising:
a first roller region comprising a first material,
a second roller region comprising a second material,
the first material and the second material connected to one another in order to form a composite roller volume element, and
the first material having a lighter density than the second material.

13. The roller as claimed in claim 2, wherein the first layer has a greater thickness in the radial direction than the second layer, and the second layer has a thickness in the radial direction between 1 mm and 2 mm.

14. The roller as claimed claim 1, wherein an overall diameter of the roller is from 40 mm to 50 mm.
